(19) United States
(12) Patent Application Publication
(10) Pub. No.: US 2006/0072387 A1
(43) Pub. Date: Apr. 6, 2006

(54) Small optical disk drive

(75) Inventor: Johannes Joseph Hubertina Barbara Schleipen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONCIS N.V., EINDHOVEN (NL)

(21) Appl. No.: 10/515,734

(22) PCT Filed: May 16, 2003
(86) PCT No.: PCT/IB03/02021

§ 371 Date: Nov. 24, 2004

(30) Foreign Application Priority Data
May 30, 2002 (EP) 02077133.3

(51) Int. Cl. G11B 7/00

(52) U.S. Cl. 369/44.19; 369/44.14; 369/112.01

(57) ABSTRACT

The invention relates to an optical disk drive, which can be built very small. In order to solve cooling problems and collecting light reflected from the disk with maximum efficiency an optical disk drive is proposed comprising:—a laser diode for generating a laser beam, said laser diode being located at a fixed position in the drive,—an objective for focussing said laser beam on an optical disk,—a light guide for guiding said laser beam from said laser diode to said objective,—a detector for detecting light reflected from the optical disk, and—a movable swing arm for carrying said objective and said detector, said detector being arranged close to said objective such that the light reflected from the optical disk through said objective is detected.

The invention relates to an optical disk drive and to a detector for use in an optical disk drive.

One of the challenges in making a small form factor optical disk drive, in particular having a small overall size or being thin for use in a notebook, is the integration of optics, mechanics and electronics making up the optical pick-up head. A multitude of solutions are already suggested. A high density data storage system with specifically shaped optical fibre as optical read/write head is, for example, disclosed in U.S. Pat. No. 6,069,861. Therein, an optics of a read/write system includes a stationary optical device for condensing a light beam and leading said light beam into an optical fibre. A distal end of the optical fibre is moveable and with a tapered configuration thereof for focusing the light emerging from the optical fibre into a beam spot on an optical recording medium. A detector detects through the optical fibre light reflected back from the recording medium.

One of the major problems to solve in integrating a laser diode, in particular a blue laser diode chip, with the rest of the optics and electronics, is the heat dissipation of the laser diode and its driving circuitry. If the optical head is positioned on a very small, low mass swing arm, cooling properties are very poor. According to U.S. Pat. No. 6,069,861 the laser for generating the laser beam as well as the photo diode for receiving reflected light are arranged stationary in the optical drive, but not on the swing arm. Thus, the optical fibre is used for guiding light from the laser to the recording medium as well as for guiding reflected light from the recording medium to the photo diode. This considerably reduces efficiency of the overall system and may cause signal detection errors.

It is therefore an object of the present invention to provide an optical disk drive, comprising a swing arm, which overcomes the above described problems, in particular which has a higher efficiency, avoids signal detection errors, can be built as compact as possible and solves the heating problem.

These objects are achieved by an optical disk drive as claimed in claim 1 comprising:
a laser diode for generating a laser beam, said laser diode being located at a fixed position in the drive,
an objective for focussing said laser beam on an optical disk,
a light guide for guiding said laser beam from said laser diode to said objective,
a detector for detecting light reflected from the optical disk, and
a moveable swing arm for carrying said objective and said detector, said detector being arranged close to said objective such that the light reflected from the optical disk through said objective is detected.

The invention is based on the idea to put a laser diode at a fixed position in the disk drive and transport the light to the optical head using a light guide, preferably an optical fibre. Detection of radial and focus tracking error signals and HF signals can be done in the optical head itself which is positioned on the moveable swing arm. Said optical head includes an objective for focusing a laser beam on the optical disk and a detector for detecting light reflected from the optical disk. Since according to the invention the detector is arranged close to said objective, particularly directly underneath the objective and next to the fibre exit, a light reflected from the optical disk can be collected with maximum efficiency and optical head functionality can be realised as compact as possible. Since the light guide is only used for transporting the laser beam from the laser diode to pupil information upon reflection at the disk is preserved, facilitating tracking and data readout. The heat dissipation from the laser diode and associated driver electronics can be easily handled by using appropriate cooling means near the laser diode and the driver electronics since these elements are arranged at a fixed position in the optical disk drive but not on the moveable swing arm.

Preferred embodiments in the optical disk drive are claimed in the dependent claims. According to a first preferred embodiment the detector is arranged around the exit of the light guide emitting the laser beam. Thus, the same objective can be used for focusing the laser beam on the optical disk and for focusing the light reflected from the optical disk on the detector. In this embodiment a split detector is preferably used having at least two detector portions, the exit of the light guide being arranged in a slit between said detector portions. The light guide exit is thus located exactly in the middle of both detector halves. By giving both detector halves a slight offset such that the distance from the optical disk to the surface of said detector halves is different, this detector can be used for spot-size detection without the use of any additional optics.

According to another preferred embodiment the detector is arranged next to the exit of the light guide so that no or not much light reflected from the optical disk is reflected back into the light guide. In order to deflect the reflected light towards the detector, a quarter wave plate and a hologram are preferably arranged between the objective and the optical disk, which hologram is preferably replicated on top of said objective or on said quarter wave plate.

According to a further aspect of the invention the detector is adapted for detection of radial and focus error tracking error signals (push-pull signals) and of HF data The detection of the push-pull signals can be realized by an appropriate subdivision of the detector, while the detection of the HF data can be realized by adding all the signals detected by the detector segments.

Preferably an optical fibre, in particular a single mode fibre, is used as said light guide. However, instead of optical fibres the use of integrated waveguides might be considered.

The invention can preferably be applied in a small sized optical disk drive wherein the laser diode is adapted for generating a blue laser beam. Further, the objective is preferably mounted on a focus control element, in particular a leaf spring, for focus control and focus and radial tracking means are provided, in particular integrated planar coils, mounted on the swing arm for focussing and radial tracking of the laser beam.

The invention also relates to a detector for use in an optical disk drive as described above for detecting light reflected from the optical disk, said detector being a split detector having at least two detector portions.

The invention will now be explained in more details with reference to the drawings, in which

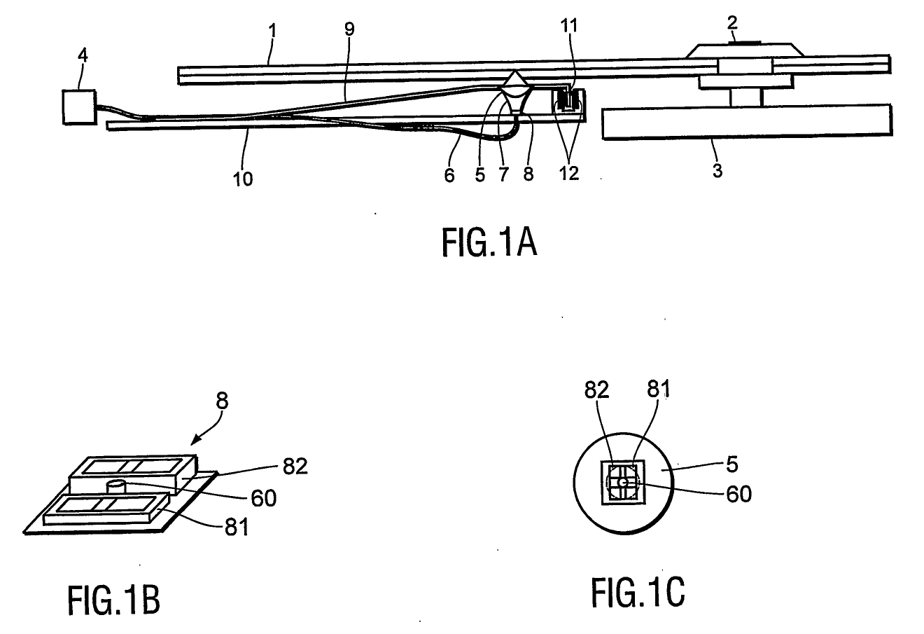

FIG. 1A shows a first embodiment of an optical disk drive according to the invention,

FIG. 1B shows a first embodiment of a detector used therein,

FIG. 1C shows a top view on the detector according to FIG. 1B,

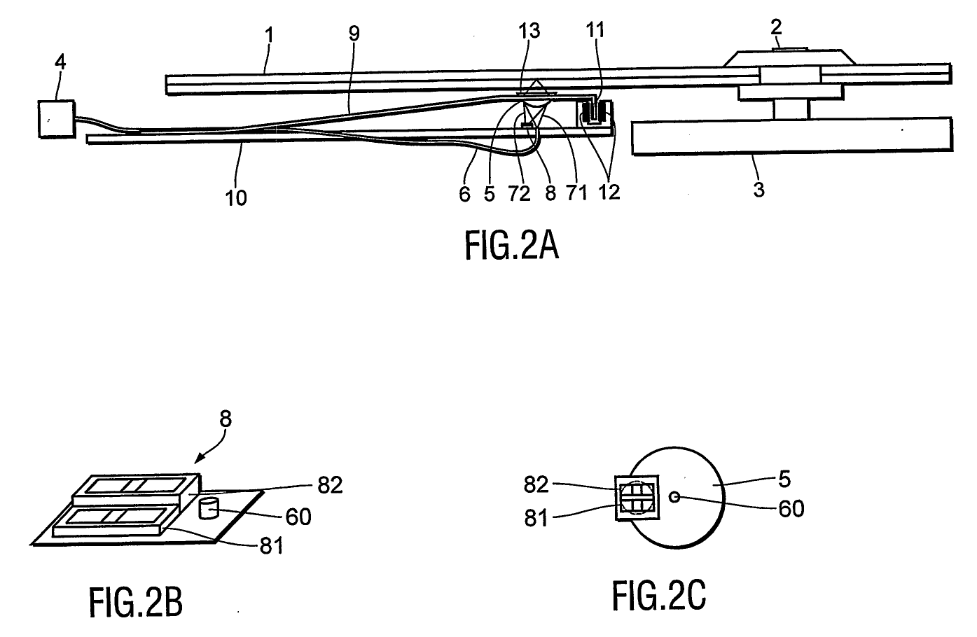

FIG. 2A shows a second embodiment of an optical disk drive according to the invention,

FIG. 2B shows a second embodiment of a detector,

FIG. 2C shows a top view on the detector according to FIG. 2B,

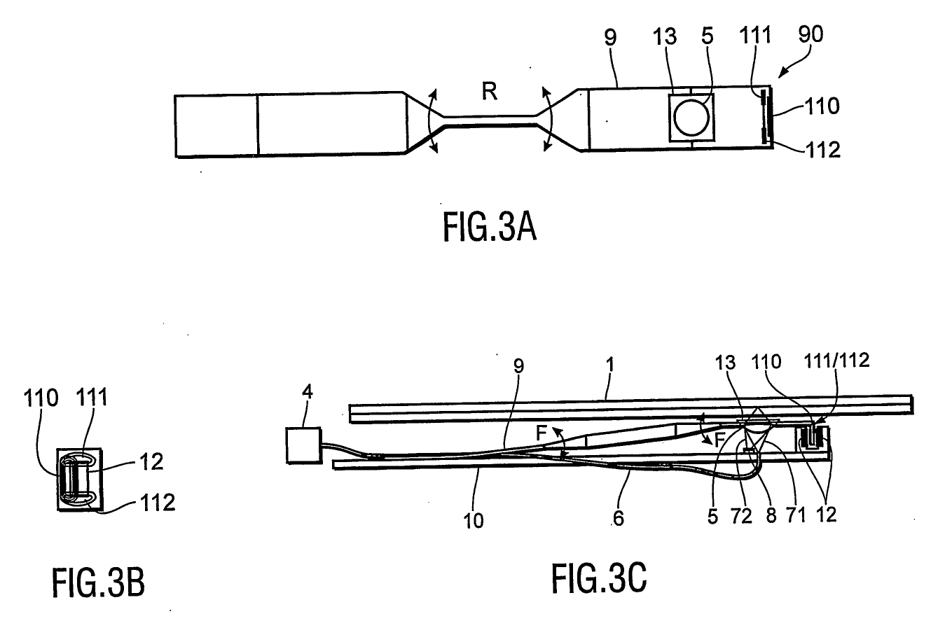

FIG. 3A/3B show a third embodiment of an optical disk drive according to the invention illustrating focus and radial tracking means.

FIG. 1A shows the main elements of a first embodiment of an optical disk drive according to the present invention. An optical disk 1, e.g. a CD or a DVD, is rotated around a spindle 2 by a spindle motor 3. A laser diode 4 is placed at a fixed position in the drive and the laser light generated by said laser diode is an objective lens 5 by means of an optical fibre 6. This fibre 6 is preferably a single mode fibre, having preferably a core diameter smaller than 1 μm, in order to ensure perfect TEM 00 output mode stability at the output. Furthermore the fibre 6 is used in this way as a beam shaping device since the laser beam 7 at the output of the fibre 6 is perfectly circular shaped. The diverging laser beam is focused by the objective 5, which is a finite conjugate both at image and object space, on the optical disk 1.

The light reflected from the disk 1 is imaged by the same objective lens 5 on top of a split detector 8. The image size is approximately the numerical aperture of the objective divided by the numerical aperture of the fibre output multiplied by the imaged spot-size on the disk, the numerical aperture of the fibre output being approximately 0.05. As shown in FIG. 1B the fibre exit 60 is located exactly in the middle of two detector halves 81, 82. Since the imaged spot by the objective lens 5 can be as large as 20 μm, the whole detector pupil can be filled, detecting push-pull and HF data. By giving both detector halves 81, 82 a slight offset, e.g. being 20-50 μm in z-height, e.g. in a direction perpendicular to the surface of the optical disk 1, this geometry can be used as spot-size detection without the use of additional optics. FIG. 1C shows a top view onto the objective lens 5 and the detector 8 as well as the fibre exit 60.

The objective lens 5 is mounted on a thin leaf spring 9 that can be actuated in vertical direction, i.e. in the direction perpendicular to the surface of the optical disk 1, for focus control. Below the objective lens the detector 8 is located on a low mass swing arm 10 to which the leaf spring 9 is mechanically connected. For the purpose of focus control the leaf spring 9 contains a planar coil 11 that is positioned in a homogeneous static magnetic field which is generated by two magnets 12 placed at the end of the swing arm 10. During actuating, due to tilt of the leaf spring 9, the objective lens 5 must tolerate a certain amount of field.

A disadvantage of the geometry shown in FIG. 1A is that laser light reflected back from the optical disk might be fedback via the optical fibre 6 into the laser diode 4. Although this is only a minor fraction of the power emitted by the laser diode 4, this feedback may give rise to a signal to noise ratio performance decrease. Another embodiment of an optical disk drive according to the invention which is improved in this respect is shown in FIG. 2A. Therein the diverging laser beam 71 is focused by an objective 5 through a quarter wave plate 13 on the optical disk 1. The light 72 reflected from the disk is imaged by the same objective lens 5 on top of the split detector 8.

Different from the embodiment shown in FIG. 1A the detector 8 is positioned next to the fibre exit 60 as shown in FIG. 2B. An additional hologram (not shown) and the quarter wave plate 13 deflect the reflected laser beam 72 towards the detector 8. The hologram can be replicated on top of the objective lens 5 or on the quarter wave plate 13. Again, the whole detector pupil can be filled, detecting push-pull and HF data. The detector is a split detector having two detector halves 81, 82 having different distances to the surface of the optical disk 1. A top view on the detector 8, the objective lens 5 and the fibre exit 60 is shown in FIG. 2C.

The advantages of this geometry compared to the embodiment shown in FIG. 1A are less or even no optical feedback into the laser diode 4 and easier detector placement since there is no interference with the optical fibre. However, polarising optics are preferably required, i.e. a quarter wave plate is used for rotation of the polarisation state. This is necessary to ensure selective use of the hologram. Only in the light path from the optical disk to the detector the hologram shall be active. Furthermore, the polarisation and the output of the optical fibre needs to be controlled, e.g. by use of a polarisation mode conserving fibre.

FIG. 3A shows a top view on a leaf spring 9 used in the optical disk drive as shown in FIG. 2A. On the front portion 90 of the leaf spring there are three integrated planar coils, one planar coil 110 for focus control F (see FIG. 3C where the directions of movement for focus control F are indicated) and two planar coils 111, 112 for radial control R. As indicated in FIG. 3B showing a side view of the front portion 90 the three coils 110, 111, 112 are placed in a fixed homogeneous magnetic field generated by coils 12 placed on the swing arm 10.

According to the invention many parts of the optical engine including the laser diode and its driving circuitry can effectively be cooled without the need to provide intensive cooling elements on the swing arm itself. Further, since the detector can be built directly underneath the objective lens and next to the fibre exit, this arrangement allows collection of the light reflected from the disk with maximum efficiency and realisation of an optical head functionality as compact as possible. A detector geometry for focus and radial tracking can easily be incorporated. Thus, the invention allows a realisation of a small form factor optical disk drive. Instead of optical fibres also the use of integrated waveguides might be considered, using an integrated 45 degrees mirror for directing the light to the objective; alternatively V-groove fiber couplers, comprising etched end mirrors also facilitate the coupling of light out of an optical fibre into the objective lens.

1. Optical disk drive comprising:
a laser diode for generating a laser beam, said laser diode being located at a fixed position in the drive,
an objective for focussing said laser beam on an optical disk,
a light guide for guiding said laser beam from said laser diode to said objective,
a detector for detecting light reflected from the optical disk, and
a movable swing arm for carrying said objective and said detector, said detector being arranged close to said objective such that the light reflected from the optical disk through said objective is detected.

2. Optical disk drive according to claim 1,
wherein said detector is arranged around the exit of the light guide emitting the laser beam.

3. Optical disk drive according to claim 2, wherein said detector is a split detector having at least two detector portions, the exit of the light guide being arranged in a slit between said detector portions.

4. Optical disk drive according to claim 3,
wherein said detector portions have different heights such that the distance from the optical disk to the surface of said detector portions is different.

5. Optical disk drive according to claim 1,
wherein said detector is arranged next to the exit of said light guide.

6. Optical disk drive according to claim 5,
further comprising a quarter wave plate and a hologram arranged between said objective and the optical disk for deflecting the light reflected from the optical disk onto said detector.

7. Optical disk drive according to claim 6, wherein said hologram is replicated on top of said objective or on said quarter wave plate.

8. Optical disk drive according to claim 1, wherein said detector is adapted for detection of a radial and focus error tracking error signals and of HF data.

9. Optical disk drive according to claim 1,
wherein said light guide is an optical fibre, in particular a single mode fibre, or an integrated waveguide.

10. Optical disk drive according to claim 1,
wherein said optical disk drive is a small sized optical disk drive and wherein said laser diode is adapted for generating a blue laser beam.

11. Optical disk drive according to claim 1,
wherein said objective is mounted on a focus control element, in particular a leaf spring, for focus control.

12. Optical disk drive according to claim 1,
further comprising focus and radial tracking means, in particular integrated planar coils, mounted on said swing arm for focussing and radial tracking of said laser beam.

13. Detector for use in an optical disk drive as claimed in claim 1 for detecting light reflected from the optical disk, said detector being a split detector having at least two detector portions.

14. Detector according to claim 13,
wherein said detector portions have different heights such that the distance to the surface of said detector portions is different.
